(19) United States
(12) Patent Application Publication
(10) Pub. No.: US 2013/0099890 A1
(43) Pub. Date: Apr. 25, 2013

(54) PROTECTION ELEMENT AND METHOD FOR PRODUCING PROTECTION ELEMENT

(71) Applicant: Yoshihiro Yoneda, Tochigi (JP)

(72) Inventor: Yoshihiro Yoneda, Tochigi (JP)

(73) Assignee: DEXERIALS CORPORATION, Tokyo (JP)

(21) Appl. No.: 13/704,774

(22) PCT Filed: Jun. 15, 2011
(86) PCT No.: PCT/JP2011/063648

§ 371 Date: Dec. 17, 2012

(30) Foreign Application Priority Data
Jun. 15, 2010 (JP) 2010-135806

(51) Int. Cl. H01H 61/02; H01H 69/02

(52) U.S. Cl. CPC H01H 61/02; H01H 69/02
USPC 337/416; 29/623

(57) ABSTRACT

A protective element that is capable of promptly reliably disconnecting a current path by taking advantage of the erosion phenomenon of a solder in a melted state. A plurality of electrodes is formed by a first electrically conductive layer deposited on a substrate and by a plurality of second electrically conductive layers. A solder paste has a wetting performance for the electrodes higher than that for the substrate and is deposited on top of the first and second electrically conductive layers formed on the substrate. The solder paste melts by at least one out of heat generated by a resistor and heat generated by a stack of the electrodes and the solder paste. As the solder paste erodes the portion of the first electrically conductive layer intermediate between the electrodes, it is attracted towards the electrodes exhibiting higher wettability by it than that of the substrate.

### TECHNICAL FIELD

This invention relates to an element for protecting an electric circuit against an over-current or an over-voltage state, and a method for producing the circuit.

The present application asserts priority rights based on JP Patent Application 2010-135806 filed in Japan on Jun. 15, 2010. The total contents of disclosure of the Patent Application of the senior filing date are to be incorporated by reference into the present application.

### BACKGROUND ART

Up to now, measures have been taken to protect an electrical circuit against at least one out of the over-current state and the over-voltage state.

In Patent Document 1, for example, melt-disruption of an interconnect pattern in case of over-current is disclosed, in which a solder is formed on part of interconnections of a printed circuit board to take advantage of the operation of erosion such as phenomenon of copper dissolution by the solder. In Patent Publication 1, it is stated that a pattern width of a melt disconnect part is made narrow to reduce the melt disconnect time, and that a slit is formed in the current flowing direction.

### RELATED TECHNICAL DOCUMENT

### Patent Publication

Patent Publication 1: Japanese Laid-Open Patent Publication H09-223854

### DISCLOSURE OF THE INVENTION

### Problem to be Solved by the Invention

The protective function described in the above Patent Publication is, after all, a function as a fuse for protection against an over-current. Viz., the function is not such a function to promptly reliably disconnect a current path in response to a non-normal signal from a voltage detection IC adapted to detect the non-normal battery voltage. Such function to promptly reliably disconnect the current path is required in e.g., a secondary protection circuit for battery protection.

On the other hand, in the protective element, a lead-free substitution solder material is attracting notice. In this connection, it is desired that, even if a solder paste mainly composed of a metal having a melting point lower than that of a solder foil mainly composed of lead is used, reflow packaging on a printed circuit board is possible.

The present invention has been proposed in view of the above depicted status of the art. It is an object of the present invention to provide a protective element in which it is possible to promptly reliably disconnect a current path by exploiting the erosion phenomenon by a solder in the melted state, and a method for manufacturing the protective element. The solder, formed of a low melting alloy, is fed with current in response to a non-normal situation, such as an over-voltage, and is melted just by self-heating due to heat generated by a resistor or by over-current. A current path may be disconnected promptly reliably by taking advantage of the erosion phenomenon exhibited by the solder in the melted state,

### Means to Solve the Problem

To accomplish the above object, the present invention provides a protective element including a substrate, a plurality of electrodes formed on the substrate, low-melting metal connected to a current path between the electrodes and melt-disconnected on heating to disconnect the current path, and a resistor that, when fed with current, generates heat that melts the low-melting metal. Each of the electrodes is composed by a first electrically conductive layer deposited on the substrate and a plurality of second electrically conductive layers spaced apart from one another in the in-plane direction of the substrate on which the first electrically conductive layer is formed. The low melting metal has a wetting performance for the electrodes higher than that for the substrate, and is deposited on the first and second electrically conductive layers formed on the substrate. The low melting metal melts by at least one out of heat generated by the resistor and heat generated by a stack of the electrodes and the low melting metal, in such a manner that, as the low melting metal erodes the portion of the first electrically conductive layer intermediate between the electrodes, the metal is attracted towards the electrodes exhibiting higher wettability by the metal than that of the substrate.

The present invention also provides a method for manufacturing a protective element including a first depositing step of forming a first electrically conductive layer on a substrate provided with a resistor that, when fed with current, generates heat to melt low melting metal, a second depositing step and a third depositing step. The second depositing step forms a plurality of second electrically conductive layers spaced apart from one another in the in-plane direction of the substrate on which the first electrically conductive layer has been deposited by the first depositing step, thereby forming a plurality of electrodes. The third depositing step fauns low melting metal on the first and second electrically conductive layers formed on the substrate. The low melting metal has a wetting performance for the electrodes higher than that for the substrate. The low melting metal is melt-disconnected by at least one out of heat generated by the resistor and heat generated by a stack of the electrodes and the low melting metal, in such a manner that, as the low melting metal erodes the portion of the first electrically conductive layer intermediate between the electrodes, the metal is attracted towards the electrodes exhibiting higher wettability by the metal than that of the substrate.

In the present invention, the low melting metal is deposited between neighbored electrodes on top of the first electrically conductive layer. Hence, the erosive action to the first electrically conductive layer, which might cause disruption of a current path, is not produced except by heat generated by the resistor or by self-heating caused by the over-current. In addition, in the present invention, the electrodes are formed by a stack of layers presenting a film thickness difference with respect to the substrate. It is thus possible that the low melting metal in the melted state is attracted by surface tension towards the electrode, whose wettability by the low melting metal is higher than that of the substrate, as the melted metal erodes the first electrically conductive layer.

Thus, according to the present invention, the solder formed of the low melting metal is melted just by self-heating due to over-current or by heat generated by the resistor fed with current in response to a non-normal situation such as over-voltage. The current path may promptly reliably be disconnected by taking advantage of the phenomenon of erosion by the solder in the so melted state.

### BRIEF DESCRIPTION OF THE DRAWINGS

FIG. 1 is a block diagram showing the global configuration of a battery pack according to the present invention.

FIG. 2 is a schematic view showing a circuit configuration of a protective circuit according to the present invention.

FIG. 3A is a cross-sectional view for illustrating the manufacturing method for the protective element 100 according to the present invention.

FIG. 3B is another cross-sectional view for illustrating the manufacturing method for the protective element 100 according to the present invention.

FIG. 4 is a top plan view showing a stack of layers of FIG. 3B.

FIG. 5 is a top plan view showing a stack of layers of FIG. 3B with flux coating.

FIG. 6 is a cross-sectional view for illustrating the state in which a current path has been melt-disconnected by a solder 116 of the protective element.

FIG. 7 is a plan view for illustrating the state in which a current path has been melt-disconnected by the solder 116 of the protective element.

FIG. 8 is a cross-sectional view for illustrating a stack of layers of a protective element according to a modification of the present invention.

FIG. 9 is another cross-sectional view for illustrating a stack of layers of the protective element according to the modification of the present invention.

FIG. 10 is a top plan view of the stack of layers of FIG. 9.

FIG. 11 is a top plan view of the stack of layers of FIG. 9 with flux coating.

FIG. 12 is a cross-sectional view for illustrating the state in which a current path is melt-disconnected by the solder 116 of the protective element according to another modification.

FIG. 13 is a plan view for illustrating the state in which a current path is melt-disconnected by the solder 116 of the protective element according to the other modification.

FIG. 14A is a cross-sectional view showing a test substrate.

FIG. 14B is a top plan view of the test substrate.

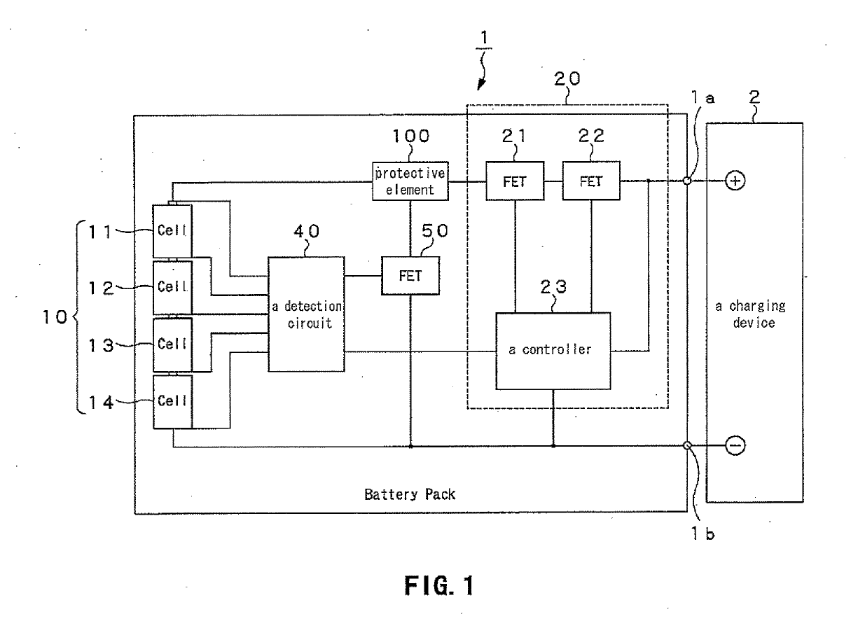

### BEST MODE FOR CARRYING OUT THE INVENTION

A preferred mode of carrying out the present invention will now be described in detail with reference to the drawings. It should be noted that the present invention is not to be restricted to the following embodiment such that a wide variety of modifications may be made without departing from the scope of the invention.

<Global Configuration>

The protective element according to the present invention is configured to safeguard an electrical circuit against at least one out of the over-current state and the over-voltage state. The protective element is used as it is built into a battery pack 1 including a battery 10 composed by four chargeable/dischargeable battery cells 11 to 14.

Viz., the battery pack 1 includes the battery 10, a charging/discharging controlling circuit 20, controlling the charging/discharging of the battery 10, and a protective element 100 that protects the battery 10 and the charging/discharging controlling circuit 20. In addition, the battery pack includes a detection circuit 40 that detects the voltage of each of the battery cells 11 to 14 and a current control element 50 that controls the operation of the voltages of the protective element 100 in response to the result of detection by the detection circuit 40.

The battery 10 is made up of a series connection of the battery cells 11 to 14 that need to be controlled so as not to fall into the over-charging or over-discharging state, such as lithium ion cells. The battery is removable connected to the charging device 2 via a positive electrode terminal 1a and a negative electrode terminal 1b of the battery pack 1 and hence is fed with a charging voltage from the charging device 2.

The charging/discharging controlling circuit 20 includes two current controlling elements 21, 22, connected in series with each other on a current path for the current flowing from the battery 10 to the charging device 2, and a controller 23 that controls the operation of the current controlling elements 21, 22. Each of the current controlling elements 21, 22 is made up of, for example, a field effect transistor, referred to below as FET, whose gate voltage is controlled by the controller 23 to control the on/off of the current path through the battery 10. The controller is run into operation by power delivered from the charging device 2 to control the operation of the current controlling elements 21, 22, depending on the result of detection by the detection circuit 40, such as to turn off the current path in case the battery 10 is in the over-discharged or over-charged state.

The protective element 100 is provided on a charging/discharging current path between the battery 10 and the charging/discharging controlling circuit 20, and has its operation controlled by the current control element 50.

The detection circuit 40 is connected to each of the battery cells 11 to 14 to detect voltage values of the battery cells 11 to 14 to transmit respective voltage values detected to the controller 23 of the charging/discharging controlling circuit 20. The detection circuit 40 outputs a control signal to control the current control element 50 in case any one or more of the battery cells 11 to 14 has fallen into the over-charging state or into the over-discharging voltage state.

It may sometimes occur that a detection signal, output from the detection circuit 40, indicates that the voltage value of any of the battery cells 11 to 14 has become offset from a pre-set range, more specifically, has fallen into the over-charging or over-discharging state. In such case, the current control element 50 sets the protective element 100 into operation to turn off the charging/discharging current path of the battery 10.

In the above described configuration of the battery pack 1, the configuration of the protective element 100 will now be explained in detail.

<Configuration of a Protective Circuit>

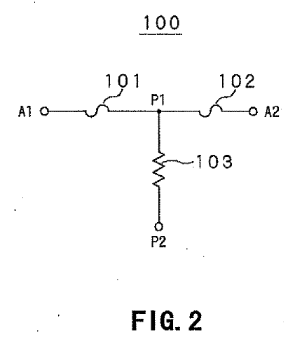

To protect the above mentioned electrical circuit within the battery pack 1 from the over-current or over-voltage state, the protective element 100 according to the present invention has the circuit configuration shown in FIG. 2.

Viz., the protective element 100 includes fuses 101, 102 formed of low-melting metal which melts and becomes disrupted on heating, and a resistor 103 which, when fed with current, emits heat to melt the fuses 101, 102, as shown in FIG. 2.

The fuses 101, 102 are inherently formed by a single member which is formed of low melting metal and which is split into two parts to form a circuit shown. Viz., the two parts are joined together at a junction point P1 to form a series circuit composed by the two parts. The fuses are connected in series with each other on a charging/discharging current path between the battery 10 and the charging/discharging controlling circuit 20. For example, the fuse 101 is connected to the battery 10 via a junction point A1 not connected to the fuse 102, whereas the fuse 102 is connected to the battery charging/discharging controlling circuit 20 via a junction point A2 not connected to the fuse 101.

The resistor 103 has one end connected via the junction point P1 to the fuses 101, 102, while having the other end connected via another junction point P2 to the current control element 50.

If, in the above described circuit configuration of the protective element 100, the resistor 103 is fed with current, the resistor emits heat which will melt the fuses 101, 102, by the operation of the current control element 50. With the fuses 101, 102 thus melted, it is possible to protect the electrical circuit within the battery pack 1.

In the protective element 100, it is necessary to use a solder formed of low melting metal for operation as fuses 101, 102 to promptly reliably disconnect a current path by taking advantage of the erosion phenomenon by the solder. To this end, the protective element is manufactured by the following process.

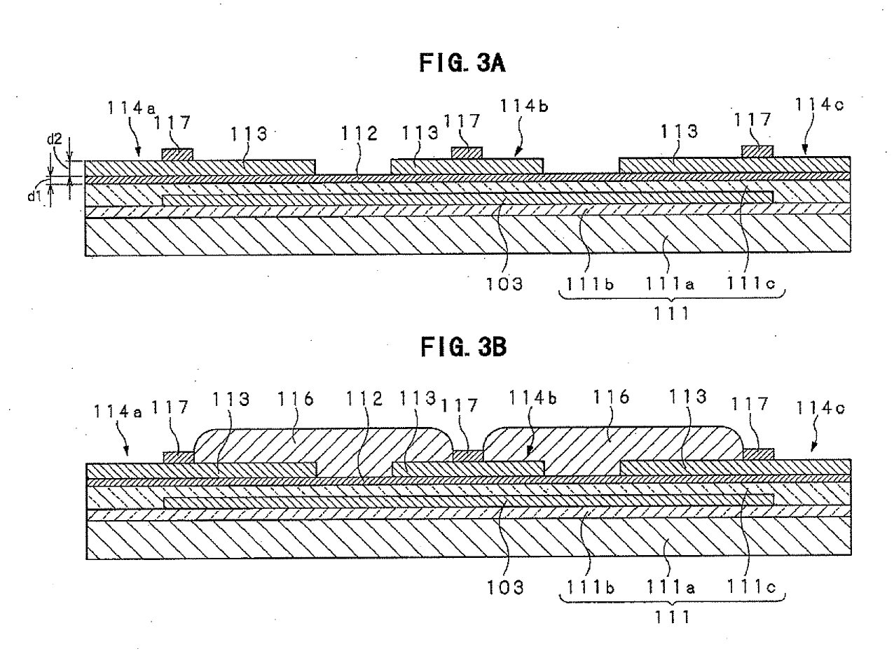

The method of manufacturing the protective element 100 according to the present invention will now be described with reference to FIGS. 3A and 3B.

Referring to FIG. 3A, the protective element 100 includes a ceramic substrate member 111a on which the resistor 103 is formed via a glass layer 111b. The protective element also includes a first electrically conductive layer 112 formed thereon via a glass layer 111c. It should be noted that the protective element according to the present invention is not limited to the above described stack of layers. For example, a stack of layers including an insulation member formed by other than glass may be used. Or, the glass layer 111b may not be used and the resistor 103 may directly be formed on the surface of the ceramic substrate member 111a. As the ceramic substrate member 111a, a substrate member of alumina or glass ceramics may, for example, be used.

Initially, in a first layering step, the first electrically conductive layer 112 of an excellently electrically conductive material, such as Ag or Pt, is formed on a substrate 111 to a film thickness d1 by printing or the like processing.

Then, in a second layering step, a plurality of second electrically conductive layers 113 of an excellently electrically conductive material, such as Ag or Pt, are deposited on the first electrically conductive layer 112 already formed on the substrate 111. The second electrically conductive layers 113 are formed at a plurality of locations separated from one another in the in-plane direction on the substrate 111 to the same film thickness d2 by printing or the like processing. This forms a plurality of electrodes 114a, 114b and 114c. It should be noted that the site of the electrode 114a corresponds to the junction point A1 in the circuit configuration of FIG. 2 described above. Similarly, the site of the electrode 114b corresponds to the junction point P1 in the circuit configuration of FIG. 2, and the site of the electrode 114c corresponds to the junction point A2 in the circuit configuration of FIG. 2. In the following, the electrodes 114a, 114b and 114c are sometimes referred to collectively as the electrodes 114.

It should be noted that both the first and second electrically conductive layers 112, 113 are formed of excellently electrically conductive materials, such as Ag or Pt. It is preferred that, to relatively promote the action of erosion of the first electrically conductive layer 112 by the solder, the physical properties of the raw materials for the first electrically conductive layer 112 are adjusted so that the layer 112 will be eroded by the solder more readily than the second electrically conductive layer 113, as later explained.

Then, in a third layering step, a lead-free solder 116, such as SnAg based solder, as low-melting metal, is applied by printing or the like processing on the substrate 111 on which the electrodes 114 are already deposited as described above. Note that the lead-free solder 116 is layered at this time in contact with the first and second electrically conductive layers 112, 113, as shown in FIG. 3B. The solder 116, deposited in this step to bridge the electrodes 114a, 114b, operates as the fuse 101, whereas the solder 116, deposited to bridge the electrodes 114b, 114c, operates as the fuse 102.

It is sufficient that the metallic material, applied in the third layering step, has, in a melted state, a wetting performance for the electrodes 114 higher than that that for the substrate 111. Viz., the metallic material is not limited to the SnAg based metallic material.

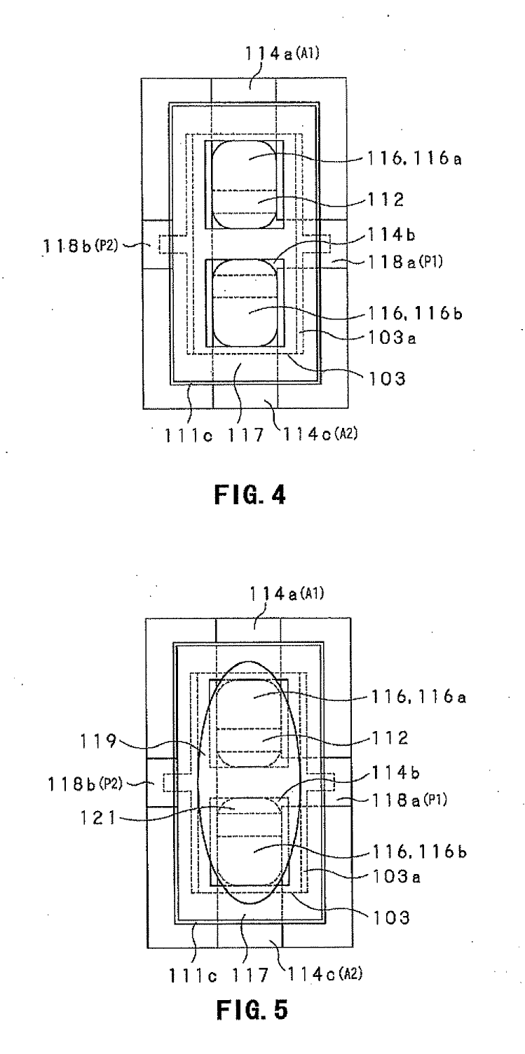

For ease in layering the solder 116 to an even film thickness, a film-forming step of forming a plurality of insulation films 117 is preferably carried out before the third layering step on each of the electrodes 114 formed by the second layering step. By forming the insulation films 117 on each of the electrodes 114, in the manufacturing method for the protective element 100, the solder 116 in the liquidus state may be retained in locations 116a, 116b, delimited by the insulation films 117, until the solder solidifies after printing. As a result, the solder 116 may be deposited to an even film thickness. The locations 116a, 116b may be seen in a plan view of FIG. 4 showing the stack of layers of FIG. 3B from above.

Referring to FIG. 4, the electrode 114b is connected to an electrode 118a equivalent to the junction point P1. The resistor 103, arranged within the bulk of the substrate 111, is connected via an electrically conductive member 103a to the electrode 118a, while being connected via an electrically conductive member 103b to an electrode 118b.

Referring to FIG. 5, a flux 119, which activates fluidity of the solder 116 in its melted state, is deposited on a site where the solder 116 has been applied. A cap 120 protects the protective element 100 in its entirety.

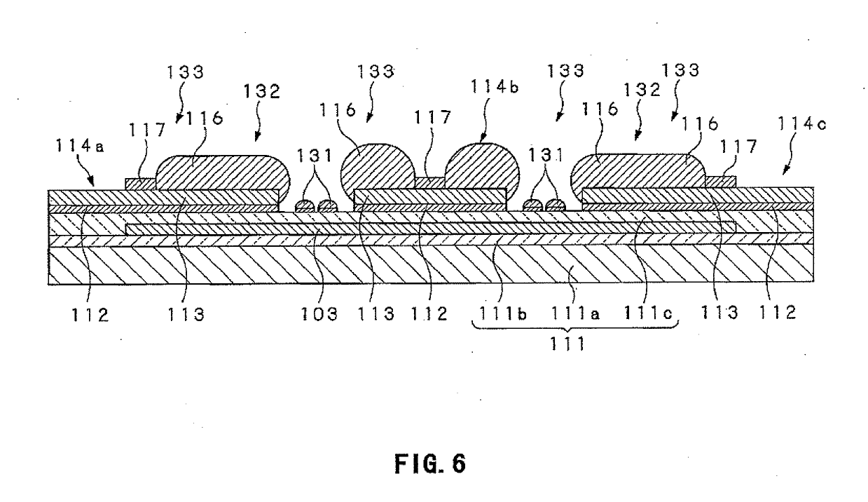

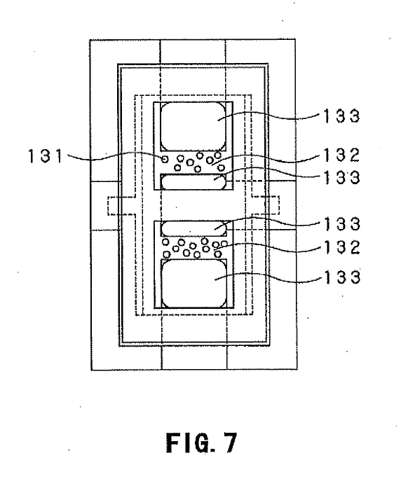

In the protective element 100, described above, the solder 116 begins to melt by at least one out of heat generated by the resistor 103 and heat generated by a layered site 121 formed by part of the electrode 114 and part of the solder 116, as shown in FIG. 5. The solder 116 in the melted state is attracted by surface tension towards the electrode 114, which is higher in wettability by the solder 116 than the substrate 111, as the solder 116 erodes the portion of the first electrically conductive layer 112 deposited between the neighbored electrodes 114, as shown in FIGS. 6 and 7.

In the protective element 100, melt residues 131 composed by the solder 116 and the first electrically conductive layer 112 are left over, as shown in FIG. 6. However, the amount of the melt residues, thus left over, is only small. Hence, the current path is melt-disrupted between the neighbored electrodes 114. Viz., in the protective element 100, the portions of the first electrically conductive layer 112, not covered by the second electrically conductive layers 113, and hence located between the neighbored electrodes 114, operate as a melt-disconnect part 132. The second electrically conductive layer 113, forming the electrode 114, operates as a solder sink 133 to attract the eroding solder.

In the protective element 100, the electrodes 114 are formed by a stack of layers in which the first and second electrically conductive layers 112, 113 provide a step of a film thickness difference relative to the substrate 111. It is thus possible that the solder 116 is drawn onto the electrodes 114 as the solder erodes only the first electrically conductive layer 112.

Moreover, in the protective element 100, the solder 116 is layered in an area of the first electrically conductive layer 112 delimited between the neighbored electrodes 114. It is thus possible to prevent the protective element 100 from being melt-disconnected under heat applied e.g., when the protective element 100 is reflow-packaged on a circuit substrate within the battery 1. Viz., the protective element 100 is not subjected to an erosive action at the first electrically conductive layer 112, and hence the current path is not disconnected, unless the protective element is self-heated due to over-current or heated by the resistor 103.

Thus, in the protective element 100, according to the present invention, the solder 116, formed of low-melting metal, is melted just due to self-heating in case of over-current or under heat generated by the resistor 103 through which the current flows in response to a non-normal state such as over-voltage. The current path may be disconnected promptly reliably by taking advantage of the phenomenon of erosion by the solder in the melted state.

In the protective element, according to the present invention, a lead-free paste-like solder is preferably used. It is because the above mentioned third layering processing may readily be performed by printing as the range of selection of solder materials is made broader. It should be noted that, in the protective element, according to the present invention, not only the lead-free paste-like solder but also a lead-based solder or a solder other than the paste-like solder, such as a solder foil, may also be used.

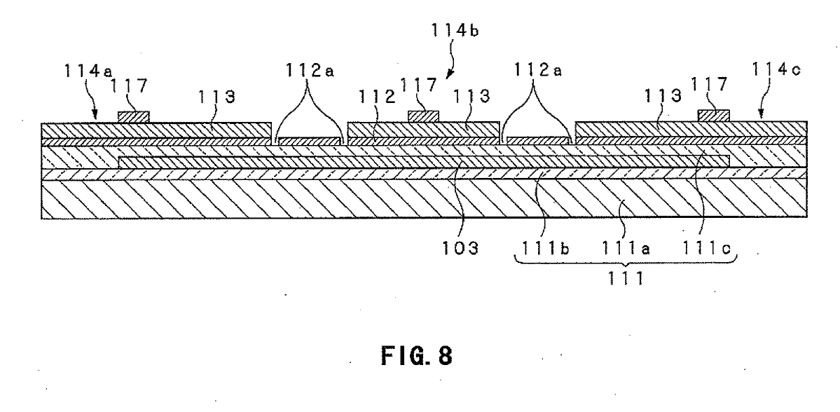

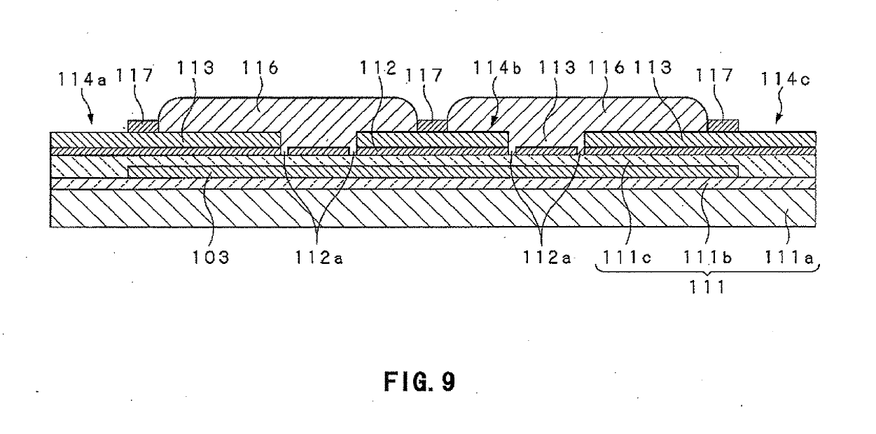

A modification of the protective element according to the present invention is shown in FIGS. 8 and 9. In this modification, the portion of the first electrically conductive layer 112, arranged between the electrodes 114 on the substrate 111 so as to be eroded by solder 116 in the melted state, includes one or more slits 112a by which the above mentioned portion of the first electrically conductive layer 112 is divided into a plurality of sections. The configuration is desirable in that the current path may be disconnected reliably and promptly.

Viz., in the protective element 100, according to the present invention, the portion of the first electrically conductive layer 112, located between the neighbored electrodes 114 on the substrate 111, is divided by the slits(s) 112a into separate sections, as shown in FIG. 8. In addition, the solder 116 is deposited to contact with both the first electrically conductive layer 112 and the second electrically conductive layer 113, as shown in FIG. 9.

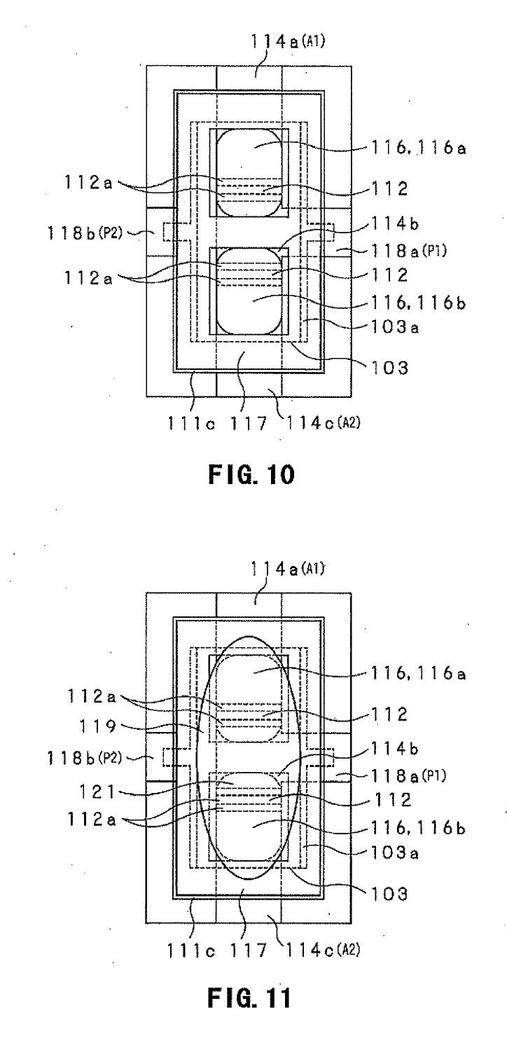

In the manufacturing process for the protective element 100 of the present modification, a plurality of insulation films 117 may be provided on the electrodes 114. It is thus possible to deposit the solder 116 to an even film thickness on location sites 116a, 116b, delimited by the insulation films 117, as indicated in a plan view of FIG. 10 showing the stack of FIG. 9 from above.

Referring to FIG. 11, in the protective element 100 of the present modification, a flux 119, which promotes fluidity of the solder 116 in the melted state, is placed on the solder 116 deposited. In addition, a cap 120 is also provided to protect the protective element 100 in its entirety.

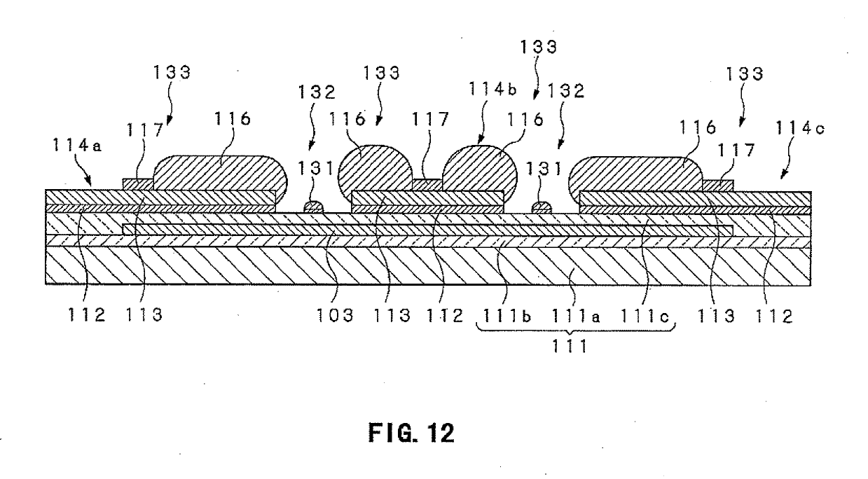

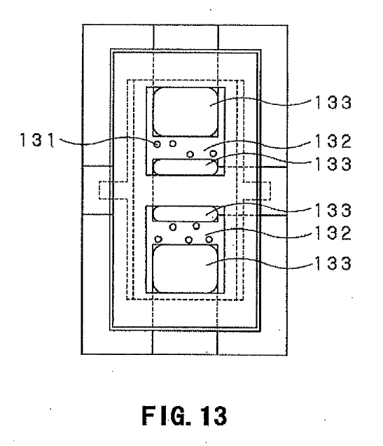

In the protective element 100 of the present modification, obtained as described above, the solder 116 in the melted state is intruded into the slits 112a, as shown in the cross-sectional view of FIG. 12. Since this permits erosion of the first electrically conductive layer 112 more efficiently, the melt residues 131, composed by the solder 116 and the first electrically conductive layer 112, are scarcely produced. Viz., in the protective element 100 of the present modification, the leakage current between the neighbored electrodes 114 may be decreased, while the current path may be disconnected promptly reliably.

In the protective element 100 according to the present invention, the first and second electrically conductive layers 112, 113 are used to provide an electrically conductive layer having a step by film thickness difference relative to the substrate 111 to form the electrodes 114. In particular, the film thickness ratio of the electrode 114 to the first electrically conductive layer 112 of 2 or more is desirable from the solder erosion characteristic against the film thickness of an electrically conductive layer. The result of a test which yielded solder erosion characteristic will now be described.

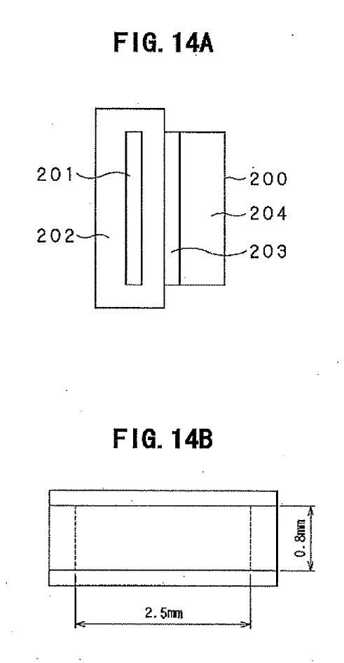

The solder erosion characteristic related to the film thickness of the electrically conductive layer was evaluated by a test which makes use of a test substrate 200 shown in FIGS. 14A and 14B. FIG. 14A shows a cross-sectional structure of a test substrate 200 and FIG. 14B depicts a top plan view of the test substrate. The test substrate 200 is made up of a substrate 202, in the bulk of which a resistor 201 is provided, an electrically conductive layer 203 having a film thickness d, and a solder 204, arranged in this order. In the present test, a sintered silver-based thick film was used as a material for the electrically conductive layer 203. The area of the sintered silver-based thick film, heated by the resistor 201, was set at 2.5 [mm]×0.8 [mm], as shown in FIG. 14B. It was presupposed to heat the electrically conductive layer 203 to approximately 650° C. by the resistor 201. A lead-based solder 204, approximately 0.1 mm in film thickness and melting at approximately 300° C., was deposited on the surface of the electrically conductive layer 203.

Under the present test conditions, the lead-based solder 204, melting at a temperature higher than with a SnAg based material, was used. However, a lead-free solder, such as SnAg based solder, is preferred in that it melts at a lower temperature and hence may erode more readily.

Under the above mentioned test conditions, heating was carried out using three different film thicknesses 7 [μm], 14 [μm] and 22 [μm] of the electrically conductive layer 203. It was found that areas eroded by the solder 204 were as indicated in the following Table 1:

TABLE 1

| film thicknesses | areas eroded | |
|---|---|---|
| 7 [μm] | 1.12 × 0.22 | [mm] |
| 14 [μm] | Φ0.12 | [mm] |

| | |
|---|---|
| 22 [μm] | no erosion |

It is seen from the above Table 1 that, under the constant heating conditions, the electrically conductive layer 203, with the film thickness d on the order of 7 [μm], is eroded severely and may properly be used as the first electrically conductive layer 112 operating as the melt-disconnect part 132. The electrically conductive layer 203, with the film thickness d on the order of 14 [μm], is eroded only mildly and may properly be used as the electrode 114 operating as the solder sink 133. The electrically conductive layer 203, with the film thickness d on the order of 22 [μm], is not eroded and may properly be used as the electrode 114.

As may be seen from the above results, in the protective element 100, it is preferred that the ratio of the film thickness of the electrode 114 to that of the first electrically conductive layer 112 is not less than 2 and, in particular, not less than 3, from the perspective of reliable melt-disconnection of the current path between the electrodes 114. By the film thickness of the electrode 114 are meant the film thicknesses of the first and second electrically conductive layers 112, 113 summed together. The ratio of the film thickness of the electrode 114 to that of the first electrically conductive layer 112 ranging between 2 and 3 is desirable in preventing the erosion from occurring in the electrodes 114 as the low cost for the raw materials of the electrically conductive layers is maintained.

As may be apparent from the above test, the film thickness of the first electrically conductive layer 112 is desirably 7 [μm] or less in view of efficient demonstration of the erosive operation. It is desirably not less than 1 [μm] which is the minimum film thickness for which no erosion may occur even in reflow packaging.

The film thickness of the electrode 114, viz., the sum of the film thicknesses of the first and second electrically conductive layers 112, 113, is desirably not less than 14 [μm] and, in particular, not less than 22 [μm], for preventing the erosive action from occurring.

The area of the melt-disconnect part 132, where the first electrically conductive layer 112 is eroded, is preferably on the order of 0.5 to 2 [mm] (width)×0.2 to 0.4 [mm] (length). If a slit is formed by way of a modification, the slit size is preferably ca. 0.5 to 2 [mm] along the width of the gap between the neighbored electrodes 114 and ca. 0.1 to 0.2 [mm] along the length of the gap between the neighbored electrodes 114 perpendicular thereto.

It is to be noted that the protective element according to the present invention may promptly reliably disconnect a current path by taking advantage of the solder erosion phenomenon in case the element is mounted in electrical circuits other than the above mentioned battery pack 1. The reason is that the protective element according to the present invention is aimed to protect a device of interest against at least one out of the over-current state and the over-voltage state.

1. A protective element comprising:
a substrate;
a plurality of electrodes formed on the substrate;
low-melting metal connected to a current path between the electrodes and melt-disconnected on heating to disconnect the current path; and
a resistor that, when fed with current, generates heat that melts the low-melting metal;
each of the electrodes being composed by a first electrically conductive layer deposited on the substrate and a plurality of second electrically conductive layers spaced apart from one another in the in-plane direction of the substrate on which the first electrically conductive layer is deposited;
the low melting metal having a wetting performance for the electrodes higher than that for the substrate and being deposited on portions of the substrate on which the first and second electrically conductive layers are formed; the low melting metal melting by at least one out of heat generated by the resistor and heat generated by a stack of the electrodes and the low melting metal, in a manner that, as the low melting metal erodes the portion of the first electrically conductive layer intermediate between the electrodes, the metal is attracted towards the electrodes exhibiting higher wettability by the metal than that of the substrate.

2. The protective element according to claim 1, wherein
the ratio of the film thickness of the electrodes to that of the first electrically conductive layer is not less than 2.

3. The protective element according to claim 1, wherein,
a portion of the first electrically conductive layer, which is provided between the electrodes formed on the substrate and which is eroded by melting of the low melting metal, includes one or more slits that separate the portion of the first electrically conductive layer into a plurality of sections.

4. The protective element according to claim 1, wherein,
the low melting metal is a lead-free solder.

5. The protective element according to claim 1, wherein,
each of the first and second electrically conductive layers contains silver.

6. A method for manufacturing a protective element comprising
a first depositing step of forming a first electrically conductive layer on a substrate provided with a resistor that, when fed with current, generates heat to melt low melting metal;
a second depositing step of forming a plurality of second electrically conductive layers spaced apart from one another in the in-plane direction of the substrate on which the first electrically conductive layer has been deposited by the first depositing step, thereby forming a plurality of electrodes; and
a third depositing step of forming low melting metal on the first and second electrically conductive layers formed on the substrate; the low melting metal having a wetting performance for the electrodes higher than that for the substrate; the low melting metal being melt-disconnected by at least one out of heat generated by the resistor and heat generated by a stack of the electrodes and the low melting metal, in a manner that, as the low melting metal erodes the portion of the first electrically conductive layer intermediate between the electrodes, the low melting metal is attracted towards the electrodes exhibiting higher wettability by the low melting metal than that of the substrate.

7. The method for manufacturing the protective element according to claim 6, further comprising a step of
forming an insulation film on each electrode formed by the second depositing step;
the low melting metal being deposited in the third depositing step on a portion of the substrate where the first and second electrically conductive layers have been deposited, in a state in which the low melting metal is delimited and isolated by the insulating film formed on each of the electrodes.

8. The method for manufacturing the protective element according to claim 6, wherein,
in the third depositing step, the paste-like low melting metal is deposited by printing on top of the first and second electrically conductive layers substrate formed on the substrate.

9. The method for manufacturing the protective element according to claim 7, wherein,
in the third depositing step, the paste-like low melting metal is deposited by printing on top of the first and second electrically conductive layers substrate formed on the substrate.
